(19) United States
(12) Patent Application Publication
(10) Pub. No.: US 2007/0082717 A1
(43) Pub. Date: Apr. 12, 2007

(54) Dual prompting device and method for mobile phone

(75) Inventors: Kuo-Chih Lee, Danshuei Township (TW); Christine Yu, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/248,062

(22) Filed: Oct. 12, 2005

(51) Int. Cl. H04M 1/00

(52) U.S. Cl. 455/575.2; 455/557

(57) ABSTRACT

A dual prompting device for incoming call of a mobile phone is provided. When a mobile phone receives an incoming signal, prompting ring or music of an incoming call not only can be sent out by a mobile phone's own speaker but also can be sent out by an externally wired speaker that placed in an earpiece wire. This device can allow people who always place their mobile phones in bags, in particular of females, to avoid mishearing of an incoming ring or music so that to avoid missing a phone call, because mobile phones are placed in bags.

### BACKGROUND OF THE INVENTION

1. Field of the Invention

This invention generally relates to a prompting device and method and in particular relates to a dual prompting device and method for incoming call of a mobile phone, wherein prompting sound not only can be sent out from a mobile phone's own speakers, but also can be sent out from speakers placed in an earpiece wire.

2. Description of the Related Art

Generally, female users don't like to hang their mobile phones on waists or chests, but to put them in bags. When mobile phones receive incoming call signals and send out rings or music, the users of mobile phones will miss the phone call because they cannot hear rings or music of an incoming call from the bag. As shown in FIG. 1, a conventional mobile phone earpiece can allow users through earpieces to receive the other party's voice and through attached microphone of an earpiece wire to delivers users'voices. Even though users put mobile phones in bags, it will not hinder a communication between the phone user and the other party but conventional mobile phone's earpieces cannot overcome the problem that users cannot hear incoming call rings when mobile phones are placed in bags.

Therefore, this invention provides a dual prompting device and method for incoming call of a mobile phone to solve the mentioned problem.

### SUMMARY OF THE INVENTION

The object of this invention is to provide a dual prompting device and method for incoming call of a mobile phone, so that mobile phone users can avoid missing phone calls because their mobile phones are put in bags that they cannot hear the incoming rings or music.

The other object of this invention is to provide a dual prompting device and method for incoming call of a mobile phone, wherein prompting sound not only can be sent out from mobile phone's own speakers but also can be sent out from an externally wired speaker placed in an earpiece wire.

In order to achieve the above-mentioned objects, this invention provides a dual prompting device for a mobile phone, it includes: an externally wired speaker, placed beyond a mobile phone; an externally wired microphone, placed beyond a mobile phone; an externally wired press key, placed beyond a mobile phone, used to switch to receive a phone call; an earpiece line-in outlet; an earpiece wire; a first switch module, placed in a mobile phone, used to switch the connection of an earpiece wire outlet; a second switch module, placed beyond a mobile phone, used to switch an externally wired speaker's output circuit and an externally wired microphone's input circuit; and a control chip, placed in a mobile phone, used to receive signals from the earpiece wire plugged in the earpiece line-in outlet and signals of the externally connected key or a built-in key being pressed, so to activate or disconnect a built-in speakers' output circuit and a built-in microphone's input circuit and to control the first switch module and the second switch module.

Wherein the earpiece line-in outlet and the earpiece wire not only can deliver earpiece's voice signals, but also can deliver the control chip's control signals to the second switch module, and also deliver singles of the plugged-in earpiece wire and the externally wired press key pressed signals to the control chip.

While the earpiece wire does not plug in the earpiece line-in outlet, the control chip detects an incoming call. The control chip will send out a signal to control the first switch module to disconnect the connection with the earpiece line-in outlet so that a built-in speaker's output circuit is activated and a built-in microphone's input circuit is disconnected. Then, the built-in speaker rings an incoming ring.

While the earpiece wire does plug in the earpiece line-in outlet, the control chip detects an incoming call. The control chip will control the second switch module to activate an externally wired speaker's output circuit and disconnect an externally wired microphone's input circuit. At the same time, the control chip activates a built-in speaker's output circuit and disconnects a built-in microphone's input circuit. Then, the built-in speaker and the externally wired speaker ring an incoming ring at the same time.

After the control chip receives the externally wired press key or a built-in press key pressed signal, the control chip controls the second switch module to activate the externally wired microphone's input circuit and disconnect the externally wired speaker's output circuit, and the control chip activates the built-in microphone's input circuit and disconnects the built-in speaker's output circuit.

This invention also provides a dual prompting method for mobile phone, which includes following steps: a control chip detecting an incoming call; the control chip ascertaining if a mobile phone is connected or disconnect with an earpiece wire; a first switch module disconnecting the connection with an earpiece line-in outlet; a control chip activating a built-in speaker's output circuit; a control chip disconnecting a built-in microphone's input circuit; detecting a built-in press key being pressed; a control chip disconnecting the built-in speaker's output circuit; a control chip activating the built-in microphone's input circuit; a first switch module connecting with the earpiece's line-in outlet; a second switch module activating an externally wired speaker's output circuit; the second switch module disconnecting an externally wired microphone's input circuit; detecting an externally wired press key being pressed; the second switch module activating the externally wired microphone's input circuit; and the second switch module disconnecting the externally wired speaker's output circuit.

### BRIEF DESCRIPTION OF THE DRAWINGS

FIG. 1 is a descriptive view of a conventional mobile phone's earpiece;

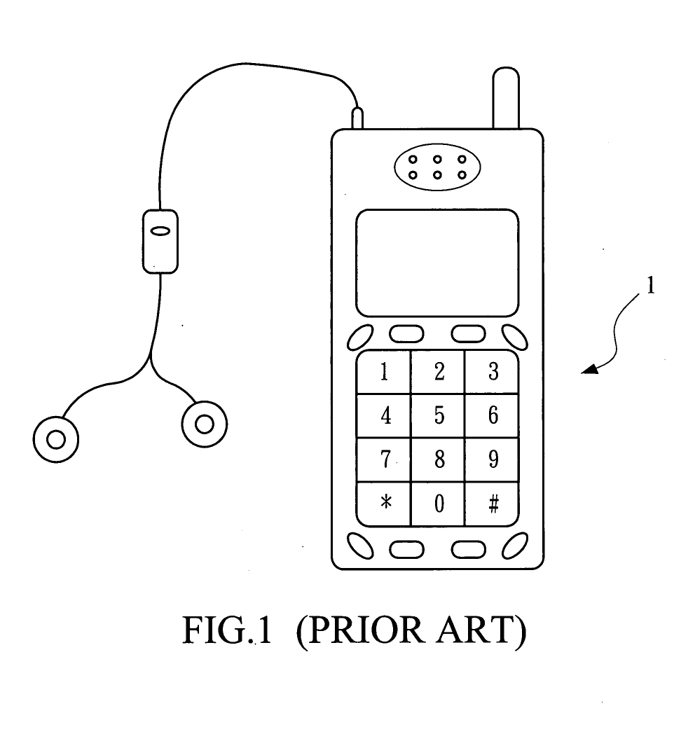

FIG. 2 is a block diagram of preferred embodiment of dual prompting device in accordance with the present invention;

FIG. 3A is a flow chart of a dual prompting method which is executed by the dual prompting device in accordance with the present invention; and

FIG. 3B is the whole processes indicated by a symbol “A” in FIG. 3A.

### DETAILED DESCRIPTION OF THE PREFERRED EMBODIMENT

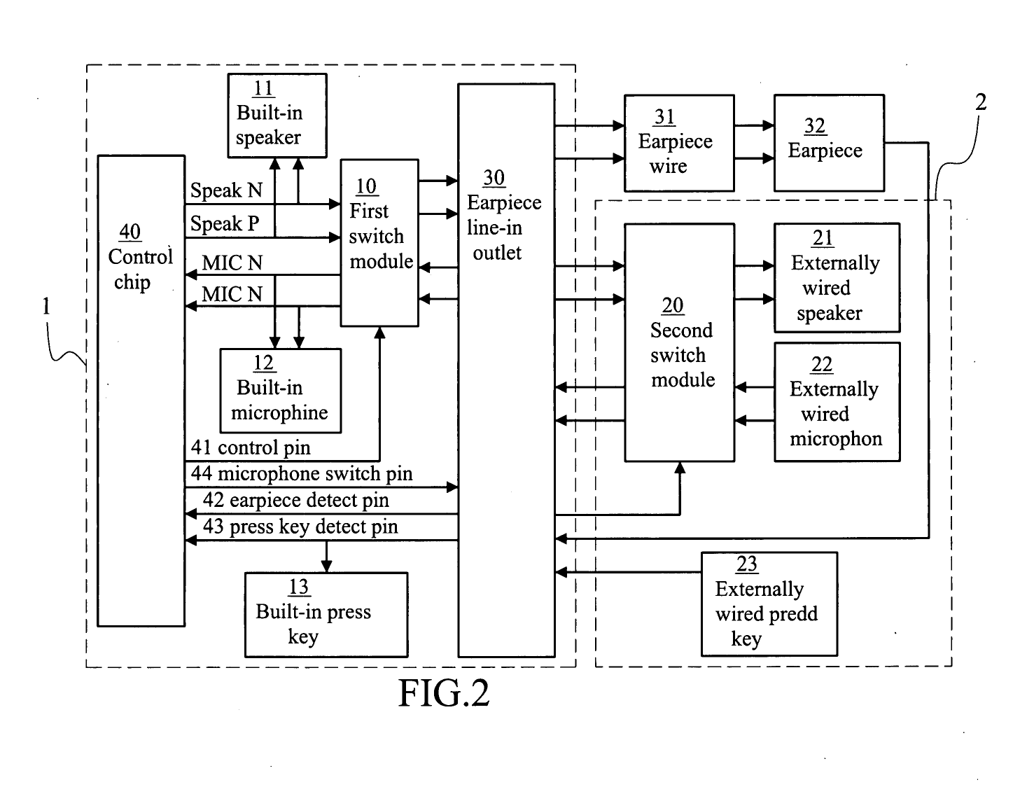

FIG. 2 is a block diagram of one embodiment of dual prompting device of the invention. This invention's mobile phone's dual prompting device includes: a first switch module 10, placed in a mobile phone 1; a second switch module 20, placed beyond a mobile phone 1; an externally wired speaker 21, placed beyond a mobile phone 1; an externally wired microphone 22, placed beyond a mobile phone 1; an externally wired press key 23, placed beyond a mobile phone 1, used to receive a phone call; an earpiece line-in outlet 30; an earpiece wire 31; and a control chip 40, placed in a mobile phone 1.

The control chip 40 further includes a Speak P pin, a Speak N pin, a MIC P pin, a MIC N pin, a control pin 41, an earpiece detect pin 42, a press key detect pin 43, and a speaker and microphone switch pin 44. The Speak P pin and Speak N pin each is presented as a voice frequency positive and negative output pin; the MIC P pin and MIC N pin each is presented as a microphone positive and negative input pin; the control pin 41 controls the first switch module 10 to connect or disconnect with the earpiece line-in outlet 30; the earpiece detect pin 42 detects the earpiece line-in outlet 30 having connected or disconnected with the height or low electric potential variation of the earpiece wire 31; the press key detect pin 43 detects the built-in press key 13 or the externally wired press key 23 being pressed or not; after or before the press key detect pin 43 receiving the signal of the press keys being pressed, the speaker and microphone switch pin 44 processes to control the second switch module 20 to activate the speaker's output circuit or the microphone's input circuit. The control chip 40 uses the control pin 41 to connect and control the first switch module 10 to connect or disconnect with the earpiece line-in outlet 30. The control chip 40 also controls the output circuit of a built-in speaker 11 and the input circuit of a built-in microphone 12.

The earpiece line-in outlet 30 and the earpiece wire 31 not only can deliver a voice signal of earpiece, but also can deliver the signals of the Speak P pin, the Speak N pin, the MIC P pin, the MIC N pin, the earpiece detect pin 42, the press key detect pin 43, and the speaker and microphone switch pin 44. When the earpiece wire 31 plugged in the earpiece line-in outlet 30, once having an incoming call, the control chip 40 will control the first switch module 10 through the control pin 41 and let the above-mentioned pin's signal wire through the first switch module 10 connects with the earpiece line-in outlet 30. When the earpiece wire 31 does not connect with the earpiece line-in outlet 30, once having an incoming call, the control chip 40 will, through the control pin 41, control the first switch module 10 to disconnect the first switch module 10 with the earpiece line-in outlet 30.

The first switch module 10 is place in a mobile phone 1 to connect with the Speak P pin, Speak N pin, MIC P pin, MIC N pin, control pin 41, earpiece detect pin 42, press key detect pin 43 and speaker and microphone switch pin 44. When the control chip 40 detects an incoming call, depending on if the earpiece wire 31 inserts into the earpiece line-in outlet 30, the first switch module 10 receives the signal of the control pin 41 of the control chip 40 and is controlled to determine, other than the control pin 41, the above-mentioned pins' signal wire connecting or disconnecting with the earpiece line-in outlet 30, and is controlled.

The second switch module 20 can be through the earpiece wire 31 and the earpiece line-in outlet 30 connecting with the Speak P pin, Speak N pin, MIC P pin, MIC N pin, and speaker and microphone switch pin 44 and through signal wires separately connecting with the externally wired speaker 21 and the externally wired microphone 22. When the earpiece wire 31 connects with the earpiece line-in outlet 30 and the control chip 40 detects an incoming call, the control chip 40 can be through the speaker and microphone switch pin 44 to control the second switch module 20 to activate the output circuit of externally wired speaker 21 and disconnect the input circuit of externally wired microphone 22. When the press key detect pin 43 of control chip 40 detects the externally wired press key 23 being pressed, the control chip 40 can be through the speaker and microphone switch pin 44 to control the second switch module 20 to activate with the input circuit of externally wired microphone 22 and disconnect the output circuit of externally wired speaker 21.

The externally wired press key 23, through the earpiece wire 31 and the earpiece line-in outlet 30, delivers the key pressed signal to the press key detect pin 43.

A conventional earpiece 32, through the earpiece wire 31 and the earpiece line-in outlet 30, connects with the earpiece detect pin 42. When the conventional earpiece 32, through the earpiece wire 31, connects with the earpiece line-in outlet 30, the earpiece detect pin 42 will be at a low electric potential. The conventional earpiece 32, also through the earpiece wire 31 and an earpiece line-in outlet 30, receives voice signals sent out by the control chip 40 to allow users to receive the other party's voice.

The second switch module 20, the externally wired speaker 21, the externally wired microphone 22, and the externally wired press key 23 can be fabricated as an externally wired module 2, and the externally wired module 2 is packed in a case.

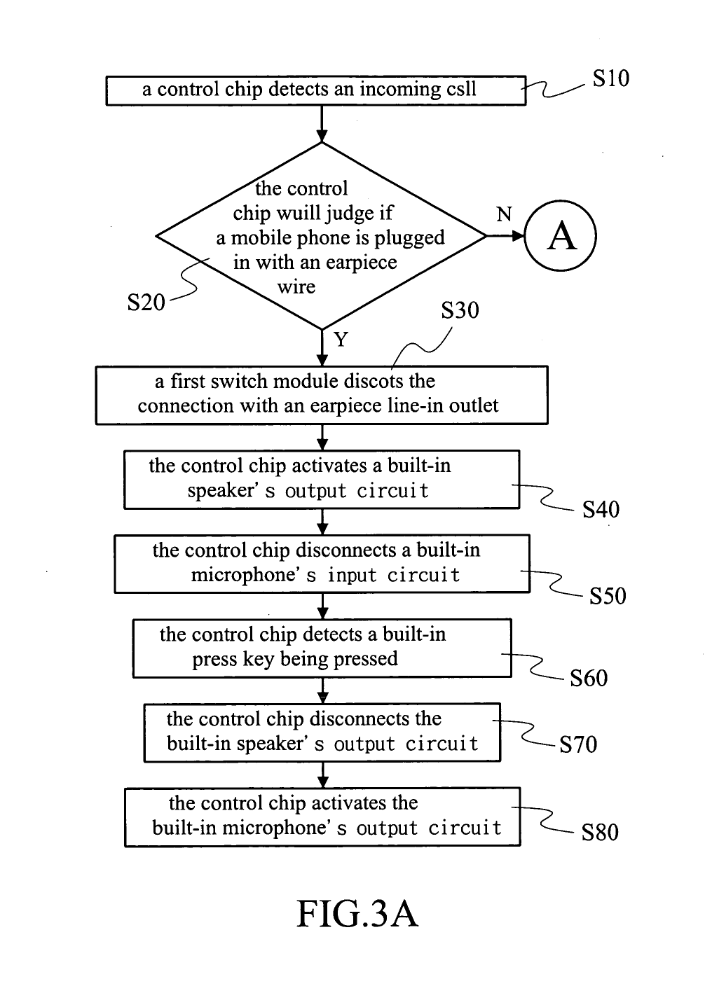

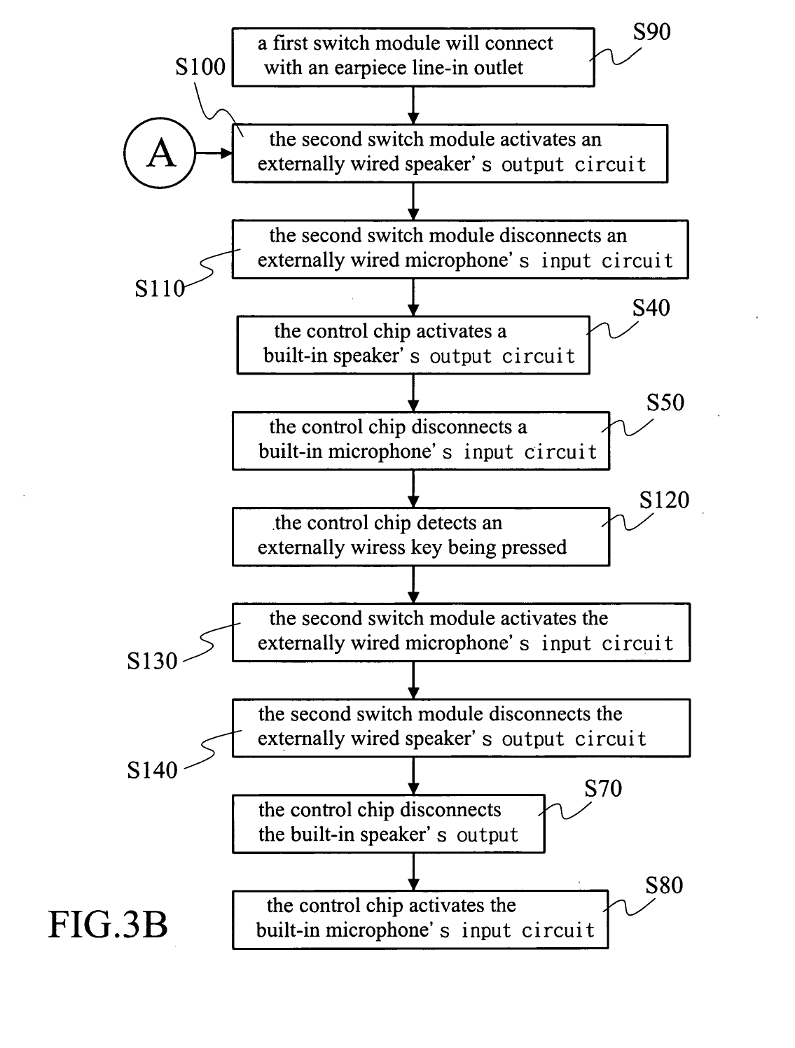

FIG. 3A and FIG. 3B are flow charts of a dual prompting method which is executed by the dual prompting device according to the invention, wherein the FIG. 3B is the whole processes indicated by a symbol “A” in FIG. 3A. According to this embodiment, while a control chip detects an incoming call (S10); the control chip will judge if a mobile phone is plugged in with an earpiece wire (S20); if an earpiece wire has been plugged in, a first switch module disconnects the connection with an earpiece line-in outlet (S30); the control chip activates a built-in speaker's output circuit (S40), and the built-in speaker rings an incoming ring; the control chip disconnects a built-in microphone's input circuit (S50); the control chip detects a built-in press key being pressed (S60); the control chip disconnects the built-in speaker's output circuit (S70); and the control chip activates the built-in microphone's input circuit (S80), and at this moment users can use the built-in microphone to have a voice communication with the other party. If an earpiece wire is not connected, the first switch module will connect with an earpiece line-in outlet (S90); a second switch module activates an externally wired speaker's output circuit (S100); and the second switch module disconnects an externally wired microphone's input circuit (S110); and the control chip activates a built-in speaker's output circuit (S40); and the control chip disconnects a built-in microphone's input circuit (S50), and then both the external speaker and the built-in speaker ring an incoming ring; when the control chip detects an externally wired press key being pressed (S120); the second switch module activates the externally wired microphone's input circuit (S130); and the second switch module disconnects the externally wired speaker's output circuit (S140); and the control chip disconnects the built-in speaker's output circuit (S70); and the control chip activates the built-in microphone's input circuit (S80), and at this moment users can use the externally wired microphone or the built-in microphone to have voice communication with the other party.

What is claimed is:

1. A dual prompting device, comprising:
an externally wired speaker, placed beyond a mobile phone;
an externally wired microphone, placed beyond the mobile phone;
an externally wired press key, placed beyond the mobile phone, used to receive an incoming phone call;
an earpiece line-in outlet;
an earpiece wire;
a first switch module, placed in the mobile phone, used to switch connection with the earpiece line-in outlet;
a second switch module, place beyond the mobile phone, used to activate or disconnect the externally wired speaker's output circuit and the externally wired microphone's input circuit; and
a control chip, placed in the mobile phone to receive a signal of the earpiece wire inserting into the earpiece line-in outlet and a pressed signal of the externally wired press key or a built-in press key, of which the control chip can activate or disconnect a built-in speaker's output circuit and a built-in microphone's input circuit, and can control the first switch module to connect or disconnect with the earpiece line-in outlet, and control the second switch module to activate or disconnect with the externally wired speaker's output circuit and the externally wired microphone's input circuit.

2. The dual prompting device according to claim 1, wherein the second switch module, the externally wired speaker, the externally wired microphone, and the externally wired press key can be fabricated as an externally wired module and the externally wired module can be packed in a case.

3. A dual prompting method, comprising:
an externally wired speaker, placed beyond a mobile phone;
an externally wired microphone, placed beyond the mobile phone;
an externally wired press key, placed beyond the mobile phone to receive an incoming phone call;
an earpiece line-in outlet;
an earpiece wire;
a control chip, placed in the mobile phone, further comprising a Speak P pin, a Speak N pin, a MIC P pin, a MIC N pin, a control pin, an earpiece detect pin, a press key detect pin, and a speak and microphone switch pin;
a first switch module, placed in the mobile phone, connecting the Speak P pin, Speak N pin, MIC P pin, MIC N pin, control pin, earpiece detect pin, press key detect pin, and speaker and microphone switch pin; and
a second switch module, placed beyond the mobile phone, through the earpiece wire and the earpiece line-in outlet connecting with the Speak P pin, Speak N pin, MIC P pin, MIC N pin, and speaker and microphone switch pin, and through signal lines connecting separately with the externally wired speaker and externally wired microphone.

4. The dual prompting device according to claim 3, wherein the second switch module, the externally wired speaker, the externally wired microphone, and the externally wired press key can be fabricated as an externally wired module and the externally wired module can be packed in a case.

5. The dual prompting device according to claim 3, wherein when the earpiece wire does not connect with the earpiece line-in outlet, the earpiece detect pin is at height electric potential, and when the earpiece wire does connect with the earpiece line-in outlet, the earpiece detect pin is at low electric potential.

6. A dual prompting method, comprising the following steps:
detecting an incoming call by a control chip;
judging a mobile phone if it is connecting or disconnecting with an earpiece wire by the control chip;
disconnecting with an earpiece line-in outlet by a first switch module;
activating a built-in speaker's output circuit by the control chip;
disconnecting a built-in microphone's input circuit by the control chip;
detecting a built-in press key whether it is pressed;
disconnecting the built-in speaker's output circuit by the control chip;
activating the built-in microphone's input circuit by the control chip;
connecting the first switch module with the earpiece line-in outlet;
activating an externally wired speaker's output circuit by a second switch module;
disconnecting an externally wired microphone's input circuit by the second switch module;
detecting an externally wired press key being pressed;
activating with the externally wired microphone's input circuit by the second switch module; and
disconnecting with the externally wired speaker's output circuit by the second switch module.

7. The dual prompting method according to claim 6, wherein after the step of disconnecting an externally wired microphone's input circuit by the second switch module, further comprises the steps of activating a built-in speaker's output circuit by the control chip and disconnecting a built-in microphone's input circuit by the control chip, and after the step of disconnecting with the externally wired speaker's output circuit by the second switch module, further comprises the steps of disconnecting the built-in speaker's output circuit by the control chip and activating the built-in microphone's input circuit by the control chip.
